(19) United States
(12) Patent Application Publication
(10) Pub. No.: US 2004/0145744 A1
(43) Pub. Date: Jul. 29, 2004

(54) Measuring array

(76) Inventors: Hans-Jurgen Dobschal, Kleinromstedt (DE); Reinhard Steiner, Stadtroda (DE); Jorg Bischoff, Ilmenau (DE)

Correspondence Address: Doulas J Christensen, Patterson Thuente skaar & Christensen, 4800 IDS Center, 80 South Eighth Street, Minneapolis, MN, 55402, US

(21) Appl. No.: 10/472,158

(22) PCT Filed: Sep. 18, 2002
(86) PCT No.: PCT/EP02/10474

(30) Foreign Application Priority Data
Sep. 24, 2001 (DE) 101-46-944.6

(51) Int. Cl. G01N 21/47

(52) U.S. Cl. 356/446

(57) ABSTRACT

In a measurement arrangement comprising a source of radiation (1), a subsequently arranged deflecting device (5), onto which a beam (2) emitted by the source of radiation (1) can be directed and which beam it deflects in different directions in a time-sequential manner, and further comprising first and second optical devices (9, 10) as well as a detector (6), the first optical device (9) deflecting each of the beams coming from the deflecting device (5) as a beam of measurement onto a point (P) on a specimen (11) to be arranged in a position for measurement, so that the angle of incidence of the beam of measurement on the specimen (11) varies as a function of the direction, and wherein specimen beams coming from the specimen due to the interaction of the beams of measurement with the specimen are deflected onto the detector (11) by means of the second optical device (10), at least one of said two optical devices (9, 10) comprises a diffractive element (7) for deflection, by which the beams incident from different directions are diffracted such that the diffracted beams of a predetermined order of diffraction are focussed in one point (P, D).

The present invention relates to a measurement arrangement comprising a source of radiation, a subsequently arranged deflecting device, onto which a beam emitted by the source of radiation can be directed and which beam it deflects in different directions in a time-sequential manner, and further comprising first and second optical devices as well as a detector, the first optical device deflecting each of the beams coming from the deflecting device as a beam of measurement onto a point on a specimen to be arranged in a position for measurement, so that the angle of incidence of the beam of measurement on the specimen varies as a function of the direction, and wherein specimen beams coming from the specimen due to the interaction of the beams of measurement with the specimen are deflected onto the detector by means of the second optical device.

Such a measurement arrangement is used, in particular, to measure angle-dependent diffraction effects on finely structured surfaces and is described, for example, in DE 199 14 696 A1. In the measurement arrangement described in DE 199 14 696 A1, the first and second optical devices are realized as mirrors or mirror segments. This leads to a complicated and intricate mirror arrangement. Also, adjusting the individual mirrors represents a non-negligible amount of work.

In view thereof, it is an object of the invention to improve a measurement arrangement of the aforementioned type such that its structure is simplified.

According to the invention, this object is achieved, in a measurement arrangement of the aforementioned type, in that at least one of said two optical devices comprises a diffractive element for deflection, which diffracts the beams incident from different directions such that the diffracted beams of a predetermined order of diffraction are focussed in one point.

The use of the diffractive element advantageously allows mirrors or mirror elements to be saved, thus simplifying the structure of the measurement arrangement. On the other hand, if the diffractive element is reflective, it acts as an ellipsoidal mirror for the predetermined order of diffraction (which is preferably not the zeroth, but a higher order of diffraction, e.g. the positive, or negative, first order of diffraction), allowing to deflect all beams coming from the deflecting device onto the specimen, or to deflect all beams coming from the specimen onto the detector.

The diffractive element may also be of the transmitting type. In this case, it acts like a lens having two points which are optically conjugated relative to each other. The focussing effect of the diffractive element (transmitting or reflective type) for the predetermined order of diffraction is preferably ensured for all beams coming from the first point, which impinge on the diffractive element within a predetermined angular range. Advantageously, the position of both points may be selected relatively freely by forming the diffractive element accordingly.

In this case, a point always means the surface or the spatial element on which the focussed beams impinge or into which said beams are focussed.

The diffractive element of the second optical device also has the effect that, even if there is conical diffraction on the specimen, all specimen beams are deflected onto the detector. Conical diffraction occurs when the grating vector of the grating structure to be examined (e.g. parallel, spaced apart lines) is not situated in the plane of incidence, said grating vector characterizing the direction of the periodicity of the grating. Thus, the higher orders of diffraction occurring during conical diffraction which are not situated in the plane of incidence may be detected as well.

Using the diffractive element of the first optical device, the beams deflected by the deflecting device may be deflected onto the specimen point so as to allow conical diffraction to occur (since the azimuth angle of the individual measurement beams may be different from zero), even if they are not all situated in one plane.

Further, the detector may be provided stationary relative to the optical devices and does not have to be moved during measurement. In an advantageous embodiment, the diffractive element is provided as a reflective element, by which folding of the optical path may be achieved, which leads to a more compact arrangement.

In particular, the diffractive element of the first and second optical devices may be provided as one single element. In this case, the complicated and very difficult adjustment required when both optical devices are realized as conventional mirrors is eliminated. Also, the problem that both optical devices partially shade each other is eliminated completely, and the adjustment of both diffractive elements relative to each other need no longer be performed.

In a particularly preferred embodiment of the measurement arrangement according to the invention, the diffractive element is provided on the planar side of a carrier. On the one hand, this makes the measurement arrangement according to the invention more compact and, on the other hand, the manufacture of the diffractive element is also particularly simple, because the latter is formed on the planar side of the carrier.

In particular, the carrier may be a plane-parallel plate, which clearly simplifies the adjustment and alignment of the carrier during manufacture of the diffractive element and also during use in the measurement arrangement according to the invention.

Further, the diffractive element may be a phase grating. Such a phase grating is easy to manufacture with the required precision, in a reproducible manner, so that the desired effect of the diffractive element may be guaranteed.

Particularly preferably, the diffractive element is provided as a blaze grating, because, in this case, nearly the entire radiation incident on the diffractive element is diffracted into the predetermined order of diffraction (preferably, the positive or negative first order of diffraction), so that undesired diffraction losses (diffraction of a different order) can be minimized. If the blaze grating is formed by means of a holographic standing wave method, the edges of the grating depressions are steady and need not be approximated by a step function, so that, advantageously, practically no diffuse scattered light appears which would deteriorate the imaging property of the diffractive element.

In particular, the deflecting device may comprise a swivel mirror or a rotatable mirror (e.g. a galvanometer mirror), allowing to effect the desired deflection with the required precision.

The measurement arrangement according to the invention may be further embodied such that the diffractive element of the first optical device and the diffractive element of the second optical device are arranged symmetrically to a center line and that the deflecting device and the detector are arranged symmetrically to a line on which the specimen point is situated and which is perpendicular to the center line. By such symmetrical arrangement, a very compact measurement arrangement is realized, allowing to safely effect the desired measurement.

A preferred embodiment of the measurement arrangement according to the invention consists in that both diffractive elements of the optical devices are arranged symmetrically to a center line, with the diffractive elements being provided asymetrically in a direction perpendicular to the center line and symmetrically in the direction of the center line. This allows the optical devices to be realized in an extremely compact manner.

Further, in the measurement arrangement according to the invention, the diffractive element may be a switchable grating which is adjustable according to the wavelength of the beam impinging on the deflecting element. This makes it possible to adjust the diffractive element to different wavelengths during measurement, thus also enabling the angle-resolved photometric measurement to be spectrally effected, when the light source sequentially generates the beam with different wavelengths during measurement. As switchable gratings, spatial light modulators may be used in transmission or in reflection. For example, use may be made of reflective or transmissive LCD modules or of reflective tilting mirror matrices. As the source of radiation which may emit a beam with different wavelengths, a polychromatic source with a subsequently arranged adjustable monochromator may be used.

Further, in the measurement arrangement according to the invention, it is possible to arrange a polarizer between the source of radiation and the deflecting device, said polarizer having the effect that the beam impinging on the deflecting device has a predetermined polarization condition, and that the detector comprises several independently readable detector pixels preceding which there are arranged analyzers having different transmission directions. This further embodiment allows information to be obtained on the change of the polarization condition due to the interaction with the specimen, allowing to effect an angle-resolved ellipsometric measurement. If the detector also comprises at least one detector pixel by which the intensity of the beam diffracted on the specimen may be detected (independently of the polarization condition of the beam), the angle-resolved photometric measurement described above is also effected at the same time.

A further embodiment of the measurement arrangement according to the invention consists in that a stop is provided in the optical path from the specimen to the detector, said stop being movable as a function of the deflection caused by the deflecting device such that specimen beams of one or several predetermined orders of diffraction are cut off and, thus, do not impinge on the detector. This ensures that only specimen beams of one or several desired orders of diffraction are detected by the detector.

The invention is explained in more detail below, essentially by way of example, with reference to the drawings, wherein:

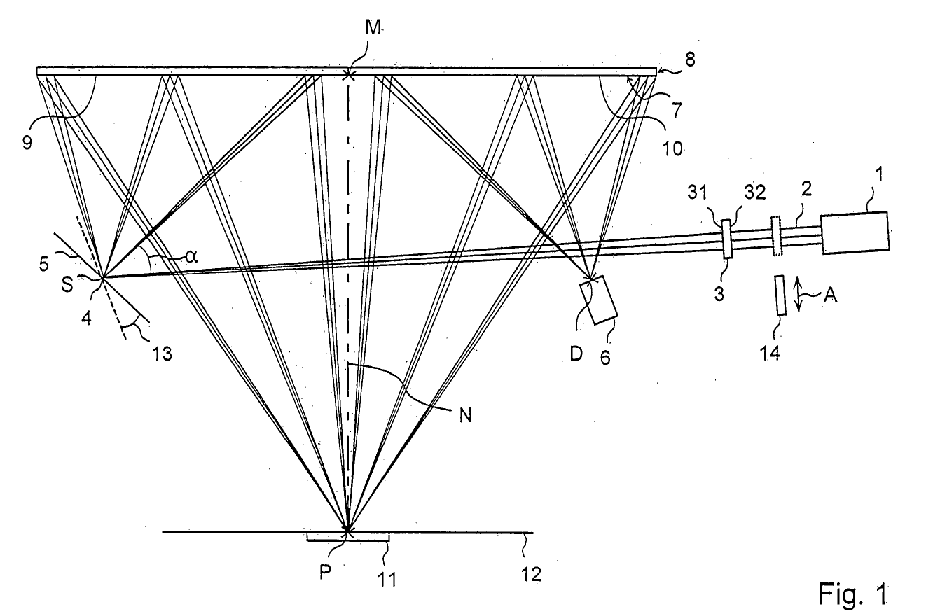

FIG. 1 shows a schematic view of the measurement arrangement according to the invention;

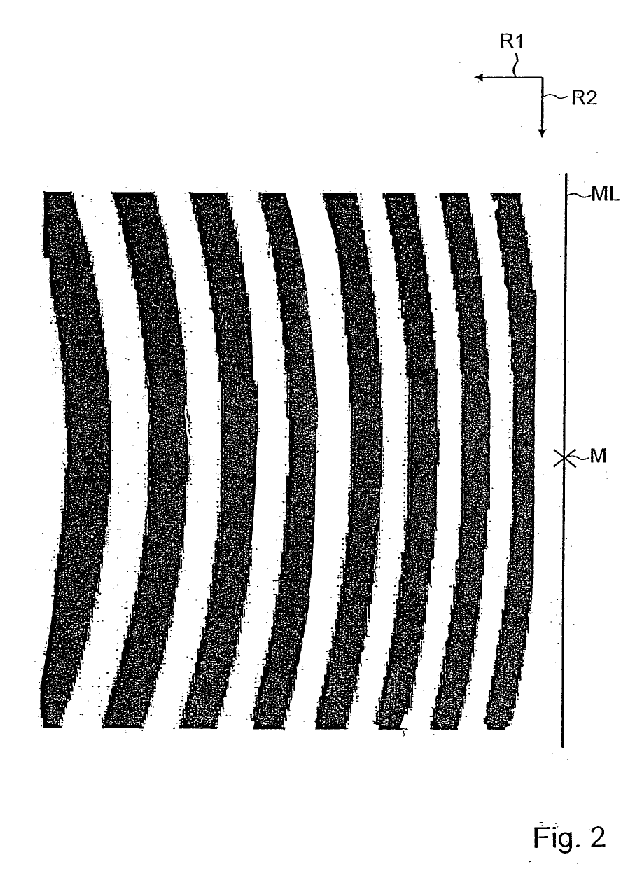

FIG. 2 shows a schematic top view of part of the reflection grating;

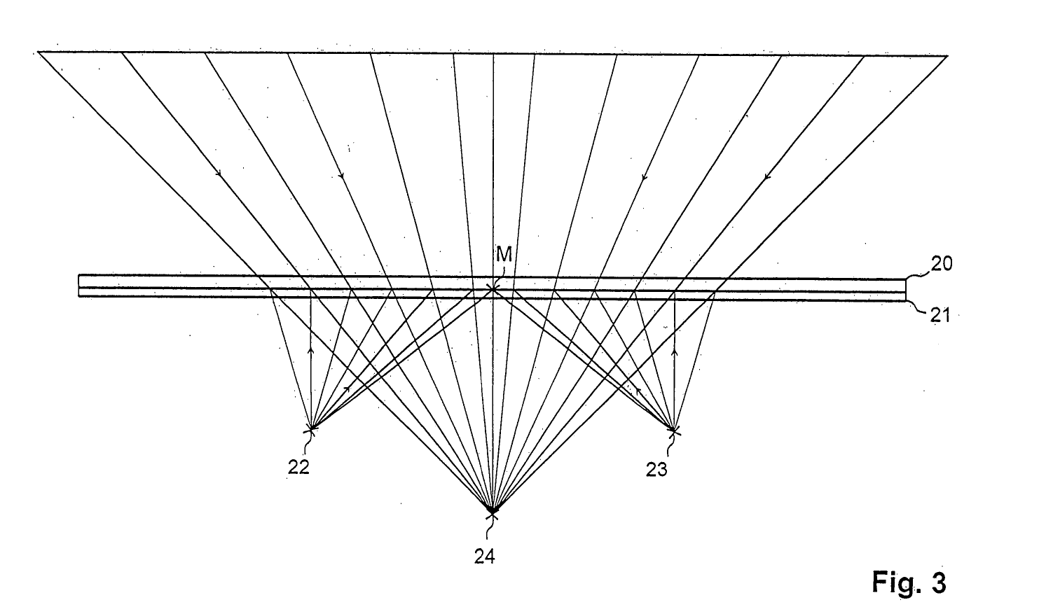

FIG. 3 a schematic view for describing the manufacture of the reflection grating, and

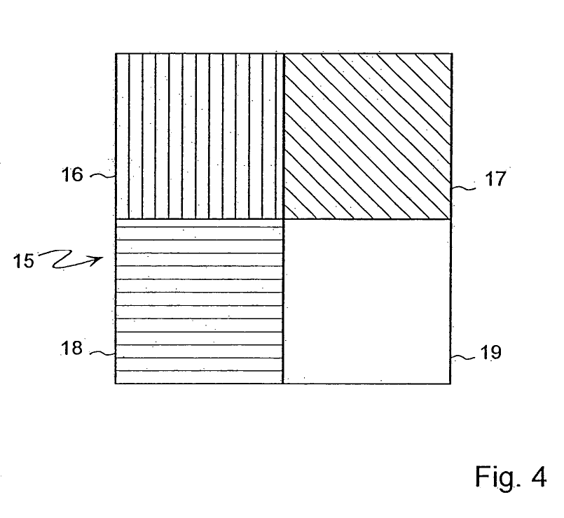

FIG. 4 shows a schematic view of the polarizing mosaic filter.

As is evident from the schematic representation of FIG. 1, the measurement arrangement according to the invention comprises a light source 1 (for example, an argon ion laser) which emits a coherent beam 2 having a predetermined wavelength (in the case of the argon ion laser, the wavelength is 457.9 nm), as well as a lens 3 and a rotating mirror 5 which is rotatable about an axis of rotation 4. In this case, the beam 2 is focussed by means the lens 3 such that the focussed beam 2 impinges on the point of intersection S of the axis of rotation 4 with the drawing plane.

The measurement arrangement further contains a detector 6 as well as a reflection grating 7, which is formed on a planar side of a carrier plate 8 and comprises first and second portions 9, 10, which, as represented in FIG. 1, border on each other at a center point M.

The measurement arrangement is designed such that a specimen point P of a specimen 11 may be examined if the specimen 11 is arranged in a plane of measurement 12 extending parallel to the reflection grating 7. The specimen point P to be examined is then located on the normal N of the reflection grating 7, said normal N extending through the center point M.

As is evident from FIG. 1, the rotating mirror 5 and the detector 6 are arranged symmetrically to the normal N of the reflection grating 7, with the distance from the rotating mirror 5 (or of the point S in which the beam 2 impinges on the rotating mirror 5) to the center point M of the reflection grating 7 being 50.0 mm. Due to the symmetrical arrangement of the detector 6 relative to the rotating mirror 5, the distance from the detector 6 to the center point M is also 50.0 mm. Finally, the distance from the specimen point P to the center point M is 50.0 mm as well. The connecting line from the mirror 5 to the center point M encloses an angle of 50° with the connecting line from the specimen point P to the center point M. The same goes for the connecting line from the specimen point P to the center point M and for the connecting line from the detector 6 to the center point M.

The distance from the piano-convex lens 3 to the rotating mirror 5 is 99.34 mm, with the lens surface 31 facing the rotating mirror 5 being planar and, thus, having an infinite radius of curvature, and the other lens surface 32 having a radius of curvature of 52.461 mm. The thickness of the lens 3 is 1.0 mm, with the focal length of the lens being 100 mm at 457.9 nm. As lens material, BK7 is used which has a refractive index of 1.524612 (at 457.9 nm) and an Abbe dispersion number of 63.96 (at 546 nm).

The collimated beam 2 impinging on the point S of the rotating mirror 5 is deflected in different directions by the rotating mirror 5, with the angle of deflection α (angle between the beam 2 impinging on the rotating mirror 5 and the beam reflected by the rotating mirror 5) depending on the rotary position of the rotating mirror 5. In the presently described embodiment example, the rotating mirror 5 has a range of rotation 13 of 35°, with the surface normal of the rotating mirror forming an angle of 15 to 50° with the middle ray of the collimated beam 2, depending on the rotary position. The beam deflected by the rotating mirror 5 (in FIG. 1, three deflected beams are indicated, by way of example, for three rotary positions of the mirror) impinges on the first portion 9 of the reflection grating 7. The first portion 9 is formed such that the positive first order of diffraction of each beam coming from the rotating mirror 5 and impinging on the first portion 9 is focussed into the point P. Thus, in connection with the first order of diffraction, the first portion 9 of the reflection grating 7 acts in the manner of a mirror which images the point S in the point P. Thus, in this sense, the first portion 9 has a first focal point S and a second focal point P.

Due to this imaging property of the first portion 9 of the reflection grating 7, the angle of incidence of the beam impinging on the specimen 11 depends on the angle of deflection α such that the angle of incidence increases as the angle of deflection α increases.

The radiation coming from the specimen point P (e.g. zeroth order of diffraction or specular reflection) impinges on the second portion 10 of the reflection grating 7, which is provided such that the maximum diffraction of the positive first order of the beams incident on said portion 10 is located in the detector 6 or in a detector point D. Thus, in connection with the first order of diffraction, the second portion 10 of the reflection grating 7 effects imaging of the specimen point P in the detector point D.

Thus, the reflection grating 7 acts as a mirror element having three focal points for the beams of the first order diffracted by it, with the first focal point being the point S, the second focal point being the specimen point P and the third focal point being the detector point D. Thus, the first and second focal points, on the one hand, and the second and third focal points, on the other hand, are optically conjugated points, respectively.

FIG. 2 schematically shows a detail of the first portion 9 of the reflection grating 7 viewed from above, wherein the black lines represent depressions formed in the carrier plate 8. In this case, the line distribution (or the line curvature) of the first portion 9 is asymmetrical in a first direction R1, whereas it is symmetrical in a second direction R2 (perpendicular to the first direction R1). The first portion 9 is provided and arranged symmetrically to the second portion (not shown in FIG. 2), with respect to a center line ML, on which the center point M is located and which extends along the second direction R2.

To conduct a measurement, the collimated beams 2 are directed onto the rotating mirror 5, which is rotated through the entire range of rotation 13, so that measurement beams having different angles of incidence are directed onto the point P in a time-sequential manner. The intensity of the specimen beams (here, essentially of the specular reflection) coming from the specimen 11 thereupon, said intensity depending on the rotary position of the rotating mirror 5 and, thus, on the angle of incidence, is detected on the basis of the imaging property of the second portion 10 by means of the detector 6, so that the intensity of the specimen beams (in this case, mainly of the zeroth order of diffraction) may be detected as a function of the angle of incidence (which is also referred to as the optical signature of the specimen point or of the specimen).

If a periodic structure of the specimen 11 in the specimen point P is to be measured, the beam diameter of the incident measurement beams (focussing) is preferably selected such that it illuminates at least a few periods of the structure. In the manufacture of semiconductors, the period of such structures (such as, e.g., lines distanced from each other, which should have a predetermined width and height as well as a predetermined flank angle, if the process is carried out correctly) may be 150 nm, so that a beam diameter of several 10 μm is then aimed for. Depending on the geometry of the specimen (which changes due to process fluctuations, for example), the measured optical signature also changes, so that conclusions may be drawn, by known methods (e.g. neuronal networks), as to the actual values of the desired parameters (such as line width, line height, flank angle), on the basis of the measured optical signature.

In a further embodiment (not shown) of the measurement arrangement according to the invention, a movable stop or beam trap is arranged between the specimen 11 and the detector 6, said stop or beam trap being guided as a function of the rotary position of the mirror 5 such that the specular reflection is cut off and, therefore, does not impinge on the detector. This allows higher orders of diffraction of the specimen beams to be detected. Of course, the stop may also be embodied and moved such that only the specular reflection impinges on the detector. In this case, the higher orders of diffraction of the specimen beams are blocked out, thus ensuring that only the specular reflection is detected.

If a space-resolved measurement is to be effected using the measurement arrangement according to the invention, the distance from the specimen 11 to the reflection grating 7 is preferably adjusted such that the measurement beams (or the measurement light bundles) have as small a diameter as possible on the specimen 11 (thus, focussing results in a minimal beam diameter in the specimen point). The specimen 11 is then respectively moved, after each measurement conducted in the above-described manner, in the plane of measurement 12, so that the spatial resolution of the signature is generated by the movement of the specimen. For example, the movement of the specimen 11 is effected by means of a specimen stage (not shown), on which the specimen 11 is held, said specimen stage also being usable, at the same time, for adjustment of the distance from the specimen 11 to the reflection grating 7. Alternatively, it is also possible, of course, to move the entire measurement arrangement relative to the specimen plane 12, or to combine both movements.

In order to provide the reflection grating 7 with a very high diffraction efficiency in reflection, it and the carrier 8 consist either of a well-reflecting material, or the surface of the carrier 8 is coated with a well-reflecting material. Thus, the reflection grating 7 may be formed, for example, of aluminum or, for longer wavelengths, also of semiconductor materials (such as germanium or silicon). Alternatively, the carrier may consist of PMMA, photoresist, glass or quartz glass, having a structured side which is provided with a coating layer, e.g. of gold.

The reflection grating 7 may be manufactured holographically as follows. On a plane-parallel plate 20, which is transparent to the wavelength of 457.9 nm, there is applied a lacquer coat 21, which is responsive to said wavelength (FIG. 3). For illumination, two laser light waves (spherical waves having a wavelength of 457.9 nm) coming from the points 22 and 23 are generated, which, in the lacquer coat 21, interfere with a countercurrent laser light wave (spherical wave having a wavelength of 457.9 nm) converging on the point 24 and thus produce, in said lacquer coat 21, the latent grating structure of the grating to be formed. In doing so, the points 22, 23 and 24, in their arrangement relative to each other and to the lacquer coat 21, correspond to the points S, D and P of the measurement arrangement shown in FIG. 1.

The latent grating structure thus produced in the lacquer coat 21 is transferred to a surface relief in a wet chemical developing process, for example, so that a blaze grating is formed due to the above-described illumination. Applying a reflecting coating, such as gold or aluminum, leads to the reflection grating 7. On the other hand, the surface relief of the blaze grating in the lacquer coat may serve as a mask for suitable structuring methods (e.g. ion beam etching), in order to transfer the grating profile into the more stable material of the carrier plate 20. After said transfer, remainders of the lacquer coat 21, which are possibly still present, are removed and the structured carrier plate 20 is coated with a reflecting coating, e.g. gold, aluminum or any other metal coating, so that the reflection grating 7 is completed.

The grating edges of the holographically manufactured reflection grating 7 are steady, so that there is advantageously practically no diffuse scattered light.

Structuring may also be effected by electron beam lithography or any other suitable microstructuring methods.

In a further embodiment, the measurement arrangement according to the invention comprises a polarizer 14, which may be inserted into the parallel optical path between the light source 1 and the lens 3, as indicated by the broken-line representation of the polarizer 14 and the double arrow A in FIG. 1. Thus, polarized light (e.g. linearly polarized light) is directed onto the deflecting mirror 5. For evaluation of the change in the polarization condition, the detector 6 is hen provided as a four-quadrant detector, preceding which there is arranged a polarization mosaic filter 15 (FIG. 4).

The polarization mosaic filter 15 comprises four square fields 16, 17, 18, 19, each respectively associated with one of the four quadrants of the four-quadrant detector. The portions 16, 17, 18 are each provided with a thin metal grating whose grating period is smaller than the wavelength of the coherent beam 2, so that only light which is polarized perpendicular to the schematically shown grating lines is transmitted. Thus, by means of the corresponding quadrants of the four-quadrant detector, which are arranged following the portions 16, 17, 18, information may be obtained on the polarization condition of light reflected by the specimen. Since the fourth portion 19 is unstructured, it transmits light regardless of its polarization condition, so that the quadrant of the four-quadrant detector associated with the portion 19 is used for photometric measurement.

Thus, the measurement arrangement according to the invention allows an angle-resolved ellipsometry to be conducted in addition to the angle-resolved photometry.

As an alternative to the fixed profile of the reflection grating, a switchable, diffractive element (not shown) may also be used, which acts in an identical or similar manner as the described reflection grating 7. In contrast to the reflection grating 7, the grating structure may be adapted to different wavelengths by means of the switchable element.

Instead of a monochromatic light source, a polychromatic light source (e.g. a mercury lamp) comprising a subsequently arranged variable monochromator (e.g. a prism or a grating) is then employed.

The measurement may then be conducted such that one predetermined wavelength is first adjusted and the switchable, diffractive element is controlled for this wavelength such that the grating by means of which the desired imaging can be performed is present for the predetermined wavelength.

Thereafter, the rotating mirror is rotated in the above-described manner, and the measurement is effected. After the measurement for the first wavelength, a second wavelength is adjusted and the diffractive element is also adjusted to the second wavelength, for which purpose the rotating mirror or swivel mirror is then rotated again. Thus, a spectral and angle-dependent intensity measurement can be effected. If use is also made of the polarizer 14 and the above-described four-quadrant detector comprising the polarization mosaic filter 15, a spectral and angle-resolved ellipsometry may be additionally effected as well.

As the switchable, diffractive element, spatial light modulators, such as reflective LCD modules or reflective tilting mirror matrices, may be employed. Alternatively, spatial light modulators may also be used in transmission, e.g. transmissive LCD modules. The spatial resolution of the switchable, diffractive elements should preferably be less than a quarter of the working wavelength.

As the sensitivity (the change of the optical signature as a function of a change in the parameter to be examined, e.g. the width and height of parallel lines) is not the same for all wavelengths of the measurement beams and for all angles of incidence of the measurement beams, but depends very strongly on the respective type of specimen (e.g. photoresist on silicon, etched silicon, etched aluminum) and the respective geometries (e.g. one-dimensional or two-dimensional repetitive structures), the monochromator and the rotating mirror are preferably controlled by a control unit (not shown) such that only the relevant angles of incidence, or also the relevant range of angles of incidence, are adjusted for each wavelength. This advantageously reduces the time of measurement.

1. A measurement arrangement comprising a source of radiation (1), a subsequently arranged deflecting device (5), onto which a beam (2) emitted by the source of radiation (1) can be directed and which beam it deflects in different directions in a time-sequential manner, and further comprising first and second optical devices (9, 10) as well as a detector (6), the first optical device (9) deflecting each of the beams coming from the deflecting device (5) as a beam of measurement onto a point (P) on a specimen (11) to be arranged in a position for measurement, so that the angle of incidence of the beam of measurement on the specimen (11) varies as a function of the direction, and wherein specimen beams coming from the specimen due to the interaction of the beams of measurement with the specimen are deflected onto the detector (6) by means of the second optical device (10), characterized in that at least one of said two optical devices (9, 10) comprises a diffractive element (7) for deflection, by which the beams incident from different directions are diffracted such that the diffracted beams of a predetermined order of diffraction are focussed in one point (P, D).

2. The measurement arrangement as claimed in claim 1, characterized in that the diffractive element (7) is provided as a reflective element.

3. The measurement arrangement as claimed in claim 1, characterized in that the diffractive element (7) of the first and second optical devices is provided as one single element.

4. The measurement arrangement as claimed in any one of claims 1 to 3, characterized in that the diffractive element (7) is formed on a planar side of a carrier (8).

5. The measurement arrangement as claimed in claim 4, characterized in that the carrier (8) is a plane-parallel plate.

6. The measurement arrangement as claimed in any one of claims 1 to 5, characterized in that the diffractive element (7) is a phase grating.

7. The measurement arrangement as claimed in any one of claims 1 to 6, characterized in that the diffractive element (7) is a blaze grating.

8. The measurement arrangement as claimed in any one of claims 1 to 7, characterized in that the deflecting device comprises a swivel mirror (5).

9. The measurement arrangement as claimed in any one of claims 1 to 8, characterized in that both diffractive elements (9, 10) of both optical devices are arranged symmetrically to a center line (ML), with the diffractive elements (9, 10) each being provided symetrically in a first direction (R1) perpendicular to the center line (ML) and asymmetrically in a second direction (R2), which is parallel to the center line (ML).

10. The measurement arrangement as claimed in claim 9, characterized in that the deflecting device (5) and the detector (6) are arranged symmetrically to a line, which extends perpendicular to the center line (ML) and on which the specimen point is located.

11. The measurement arrangement as claimed in any one of claims 1 to 10, characterized in that the diffractive element (7) comprises a switchable grating which is adjustable according to the wavelength of the beam (2) impinging on the deflecting element (5).

12. The measurement arrangement as claimed in any one of claims 1 to 11, characterized in that the source of radiation (1) is provided as a polychromatic source of radiation followed by an adjustable monochromator.

13. The measurement arrangement as claimed in any one of claims 1 to 12, characterized in that a polarizer (14) is arranged between the source of radiation (1) and the deflecting device (5), said polarizer (14) having the effect that the beam (2) impinging on the deflecting device (5) has a predetermined polarization condition, and wherein the detector (6) comprises several independently readable detector pixels with which analyzers (16; 17; 18) having different transmission directions are associated.

14. The measurement arrangement as claimed in any one of claims 1 to 13, characterized in that a stop is arranged in the optical path from the specimen (11) to the detector (6), the position of said stop being changeable in a time-sequential manner as a function of the deflection of the deflecting device such that specimen beams of a predetermined order of diffraction are cut off.
